(19) United States
(12) Patent Application Publication
(10) Pub. No.: US 2008/0236129 A1
(43) Pub. Date: Oct. 2, 2008

(54) Combination Tool

(76) Inventor: Russell F. Wudi, Corona, CA (US)

Correspondence Address: FISH & ASSOCIATES, PC;ROBERT D. FISH, 2603 Main Street, Suite 1050, Irvine, CA, 92614-6232, US

(21) Appl. No.: 11/692,027

(22) Filed: Mar. 27, 2007

(51) Int. Cl. A01D 7/10; A01D 7/00

(52) U.S. Cl. 56/400.04; 56/400.16

(57) ABSTRACT

A combination tool has a rake portion and a fork portion in which the angle between the portions is preferably about 180 degrees. In further preferred aspects, the handle of the tools contemplated herein has two angled portions, and the two portions have an offset of at least 2 inches.

### FIELD OF THE INVENTION

The field of the invention is agricultural tools, and especially combination agricultural tools.

### BACKGROUND

There are various agricultural combination tools known in the art and exemplary tools are described in U.S. Pat. Nos. 685,022, 705,008, 894,491, and 1,185,426. While these tools allow use of two different tools that are movably coupled relative to each other, several disadvantages remain. Among other things, all of these tools are configured such that the fork portion is substantially straight while the rake portion is at an angle of about 90 degrees. Similarly, as described in U.S. Pat. No. 1,374,800, the angle between the fork and the rake angle is fixed at about 90 degrees. U.S. Pat. No. 1,474,650 describes a tool in which the angle between the fork and the rake is variable between about 0 degrees and 90 degrees. Such configurations are often problematic where the tines of the fork and/or rake are relatively long, which forces the operator into a non-ergonomic position. These and all other extraneous materials discussed herein are incorporated by reference in their entirety. Where a definition or use of a term in an incorporated reference is inconsistent or contrary to the definition of that term provided herein, the definition of that term provided herein applies and the definition of that term in the reference does not apply. Thus, there is still a need for improved combination tools.

### SUMMARY OF THE INVENTION

The present invention provides apparatus, systems, and methods in which a tool has a fork portion and a rake portion coupled to a common handle. Preferably, the fork portion and the rake portion form an angle of at least 120 degrees, more preferably at least 150 degrees, and most preferably between 160 degrees and 200 degrees.

In one aspect of the inventive subject matter, the fork portion has between two and four tines while the rake portion has between six and twelve tines. Most preferably, the fork portion and the rake portion are permanently coupled to each other, and are typically coupled to a shaft that accommodates an elongated handle. Where desirable, the elongated handle may be non-linear and include at least one and more typically two curved portions to increase ergonomic handling. It is further preferred that the fork portion and the rake portion are coupled to a common handle, however, in alternative aspects, the fork portion and the rake portion may have individual handles (which may be combined to a dual handle).

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a schematic illustration of one exemplary combination tool according to the inventive subject matter.

FIG. 2 is a schematic illustration of another exemplary combination tool according to the inventive subject matter.

FIG. 3 is a schematic illustration of a further exemplary combination tool according to the inventive subject matter.

FIG. 4 is a schematic illustration of yet another exemplary combination tool according to the inventive subject matter.

### DETAILED DESCRIPTION

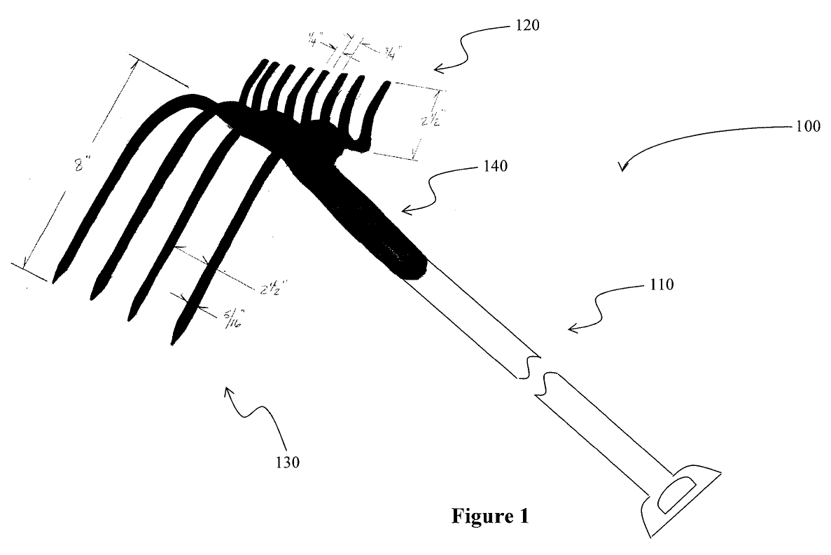

In FIG. 1 a tool 100 generally comprising a handle 110, a rake portion 120 and a fork portion 130 is shown.

Handle 110 can have any suitable dimensions. Preferred handles are at least 1 meter long, but it is contemplated that handles could have a length of 0.5 m or less (for example for close in gardening use or for children), and alternatively could have a length of up to 2 meters or longer. Such longer rakes could be useful for gardening at steep inclines. Handles can be made out of any suitable material including wood, metal, plastic and composites, and can be straight or curved. Handles can have any suitable weight, rigidity and any desirable color.

Rake portion 120 is contemplated to have a plurality of protrusions that will be called tines hereafter. Preferred rakes have at least 6 tines, and could have up to 30 tines or more. Typical gardening rakes having between 15-30 tines perform well when raking leafs or similar garden waste. Tines could be curved or straight and have a length of 2-10 cm. Preferred tines have a length between 3-8 cm, and some tines could be 20-40 cm or longer. Tines cross-sections can be round, oblong, rectangular, cross, or a combination of these (e.g. cross at base to round at tip). Tines on the rake portion can all have approximately the same lengths or some tines could be longer than others. Tines can be made out of any suitable material including wood, metal, plastic, and composites, and they can be pointed or blunt. Tines are attached to a bar made out of any suitable material; they can be fixed or replaceable, and they can be continuous or discontinuous with the bar. A handle 110 can have one or multiple bars attached, and a bar can be straight or curved.

Fork portion 130 is contemplated to have a plurality of tines. Unless otherwise noted, tines of the fork portion 130 can be described using the same criteria (such as cross-sections, materials, etc.) used for tines of the rake portion 120. Preferred forks have at least 3 tines and could have up to 5 tines. It is possible that a fork could have more than 6 tines, but one of the differences between rakes and forks is that a rake has more, generally shorter tines and a fork has fewer, longer tines. Commercially available pitchforks with five tines are well suited for moving bails of hay or working with mulch and compost. Tines could be curved or straight and have a length of 15-30 cm. Preferred tines have a length between 20-25 cm, and some tines could be as short as 10-15 cm or shorter or as long as 30 cm or longer.

In FIG. 1, the rake and fork portions are coupled to a handle by virtue of a common member 140 manufactured out of metal or any other suitable material. The rake and fork portion extend at approximately opposite directions (180°) from the handle, and the preferred angle formed between the tines of the rake and fork could be between 180° and 150° or less. Most preferably, the fork portion and the handle portion are offset relative to each other at a distance of at least 1 inch, more typically at least two inches, and more typically at least four inches.

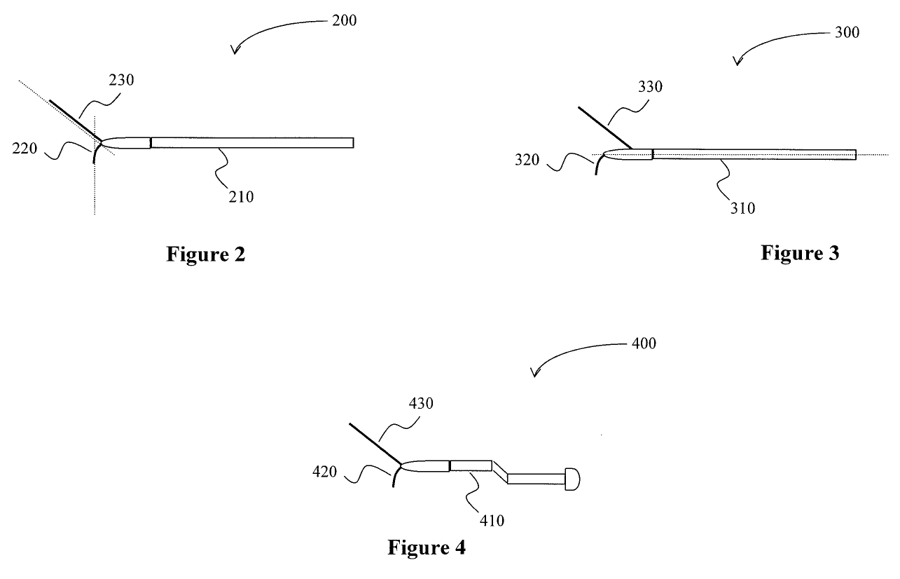

In an alternative embodiment of FIG. 2, rake 200 generally comprises a handle 210, a rake portion 220 and a fork portion 230. The handle, rake portion and fork portion of rake 200 can be described in the identical manner to rake 100 unless otherwise noted. The rake and fork portion of rake 200 extend at approximately 120° relative to each other (see angle formed by dotted lines). The preferred extension between the rake portion and the fork portion could be between 90-130° or more and 90-50° or less.

In an alternative embodiment of FIG. 3, rake 300 generally comprises a handle 310, a rake portion 320 and a fork portion 330. The handle, rake portion and fork portion of rake 300 can be described in the identical manner to rake 100 unless otherwise noted. The rake and fork portion of rake 300 are attached to a handle at separate locations. The preferred distance between a fork and a rake attachment to a handle can be between 5-10 cm or more or less than 5 cm. It is contemplated that the relative rake and fork positions in described FIGS. 1, 2 and 3 will allow to utilize the tool efficiently whereby the rake portion will not interfere when the fork portion is used and vice versa.

In an alternative embodiment of FIG. 4, rake 400 generally comprises a handle 410, a rake portion 420 and a fork portion 430. The handle, rake portion and fork rake 100 unless otherwise noted. The handle of rake 400 can be curved and/or 60 cm or less with a preferred length between 25-35 cm. Such a tool with a relatively small and curved handle could be useful for gardening in confined spaces and close quarters. Attachment of the rake portion and fork portion to handle can be by any one of the methods described for rake 100, 200 or 300.

Thus, specific embodiments and applications of combination tools have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A tool, comprising:
a rake portion and a fork portion, each of which is coupled to a handle;
the rake portion having a bar with at least six fingers extending from the bar, the fork portion having less than six fingers;
the rake portion and the fork portion forming an angle of between 130 degrees and 210 degrees; and
wherein the rake portion and the fork portion are permanently and at an offset coupled to each other.

2. The tool of claim 1, wherein the handle is at least 1 meter long.

3. The tool of claim 1, wherein the handle comprises an angled portion.

4. The tool of claim 1, wherein the rake portion and the fork portion form an angle of between 160 degrees and 200 degrees.

5. The tool of claim 1, wherein the fingers of the fork portion are at least three times the length of the fingers of the rake portion.

6. The tool of claim 1, wherein the rake portion and the fork portion have substantially the same width.

7. (canceled)
